(19) United States
(12) Patent Application Publication
(10) Pub. No.: US 2026/0225014 A1
(43) Pub. Date: Aug. 6, 2026

(54) DEVICE FOR SEPARATING GAS FROM A MIXED GAS FLOW

(71) Applicant: Anders OLSSON, Esher (GB)

(72) Inventor: Anders OLSSON, Esher (GB)

(21) Appl. No.: 19/149,976

(22) PCT Filed: Jan. 26, 2024
(86) PCT No.: PCT/SE2024/050071

§ 371 Date: Jul. 22, 2025

(30) Foreign Application Priority Data
Jan. 27, 2023 (SE) 2330052-8

(51) Int. Cl. B01D 45/14; B01D 53/24; B04B 5/08

(52) U.S. Cl. CPC B01D 45/14; B01D 53/24; B04B 5/08

(57) ABSTRACT

Device for separating gas from a mixed flow which may contain light and heavier gas fractions, liquid and/or solid particles, which device comprises a rotor with a rotor core which tapers conically from an upstream end towards a downstream end with respect to the flow direction of the mixed gas flow through the rotor, and further comprising wings arranged on the rotor core and running in the longitudinal direction of the rotor core, the width of said wings in the radial direction of the rotor increasing in the direction of the downstream end of the rotor, and a rail supported on the free edges of the wings, arranged in a spiral path and standing on one edge, forming a rotating feed screw.

### TECHNICAL FIELD OF THE INVENTION

The present invention relates to a device for separating gas from a mixed gas flow which may contain light and heavier gas fractions, liquid and/or solid particles. For simplicity, the unseparated gas flow will hereafter be referred to as a mixed gas flow, while the separated light gas fraction is referred to as a gas flow.

### BACKGROUND AND PRIOR ART

The device relates to a type of separators whereby solid particles, liquid and heavier gas fractions are suitably separated from an incoming mixed flow to be returned to the mixed flow ahead/upstream of the separator while the gas, i.e. the separated lighter gas fraction, now substantially purified from solids particles, liquid and heavier gas fractions, is discharged after/downstream of the separator.

A device of a similar type and function is previously shown in WO2021/145816 A1 where the separator serves a reactor for the extraction or recovery of hydrocarbon products from hydrocarbon-containing material by grinding and agitating the material while developing heat for gasification of hydrocarbon products contained in the material. The separator of WO2021/145816 A1 has a tubular rotor housing with an open end connected to the reactor for feeding a mixed gas flow from the reactor, and an opposite end provided with an outlet for gas. A feed screw extends through the rotor housing, which is driven in rotation by a drive unit. The feed screw is rotated at such a speed that solid particles, liquid or heavier gas fractions contained in the mixed gas flow are thrown outwards against the wall of the rotor housing. Furthermore, the feed screw has such a pitch and direction of rotation that material that is carried out towards the rotor housing wall is fed back to the reactor, against the direction of the gas flow through the rotor housing, for further processing in the reactor.

However, the device according to the invention is not necessarily limited to the above-mentioned use, although it may advantageously be implemented in the known reactor intended for the recovery of hydrocarbon products.

### SUMMARY OF THE INVENTION

The invention aims to provide an alternatively designed device for separating gas from a mixed flow of gas, solid particles and/or liquid.

The object of the invention is to provide a device with improved capacity in the separation of gas from a mixed flow of gas, solid particles and/or liquid.

The object is met by the device comprising a rotor rotatably arranged in a rotor housing with a cylindrical rotor housing wall, wherein the rotor and the rotor housing have a radial and axial extension and the axis of rotation of the rotor coincides with the center axis of the rotor housing, wherein a drive unit is connected to the rotor and operative for rotation of the rotor. Furthermore, an inlet is arranged in an upstream first end of the rotor housing for feeding an axially directed mixed gas flow to the rotor. A gas outlet is arranged at a downstream second end of the rotor housing for discharging separated gas, and a return outlet is arranged at the first end of the rotor housing for discharging an outlet flow of separated heavier gas fractions, solid particles and/or liquids/liquid droplets.

The rotor comprises a rotor core which tapers conically from an upstream end towards a downstream end of the rotor with respect to the flow direction of the gas flow through the rotor. Wings arranged on the rotor core and running in the longitudinal direction of the rotor core have a width in the radial direction of the rotor which increases in the direction of the downstream end of the rotor. A rail supported on the free edges of the wings, arranged in a spiral path and standing on one edge, forms a feed screw rotating close to the rotor housing wall with a pitch designed for feeding separated heavier gas fractions, solid particles and/or liquids/liquid droplets towards the return outlet, arranged at the upstream first end of the rotor housing.

In one embodiment, an opening may be formed through the rotor housing wall, at the downstream second end of the rotor housing, for the discharge of gas in a radial direction from the rotor housing.

In one embodiment, the inlet of the mixed gas flow at the upstream first end of the rotor housing is annular and defined by the radial distance between the rotor core and the inner periphery of the feed screw, and wherein the return outlet at the upstream first end of the rotor housing is annular and defined by the radial distance between the inner periphery of the feed screw and the rotor housing wall.

In one embodiment, the rotor core has an end plane facing the mixed gas flow, with convexly curved vane blades, protruding from the end plane and towards the mixed gas flow, in the direction of rotation of the rotor, which extend from an area inside the periphery of the rotor core to the periphery of the rotor core.

Several advantageous embodiments appear from subordinate patent claims and are described below in the detailed description of embodiment examples.

### BRIEF DESCRIPTION OF DRAWINGS

Embodiments of the invention are described in more detail below with reference to attached drawings, of which

FIG. 1 is a partially broken-away side view of the device,

FIG. 2 is a side view of a rotor included in the device,

FIG. 3 is an end view showing an upstream end of the rotor and rotor housing included in the device,

FIG. 4 is a cross-section through the rotor and rotor housing in a downstream position of the device, and

FIG. 5 is a diagram that schematically illustrates the positions of measured or calculated flow rates and acceleration forces respectively during operation of the device.

### DETAILED DESCRIPTION OF PREFERRED EMBODIMENTS

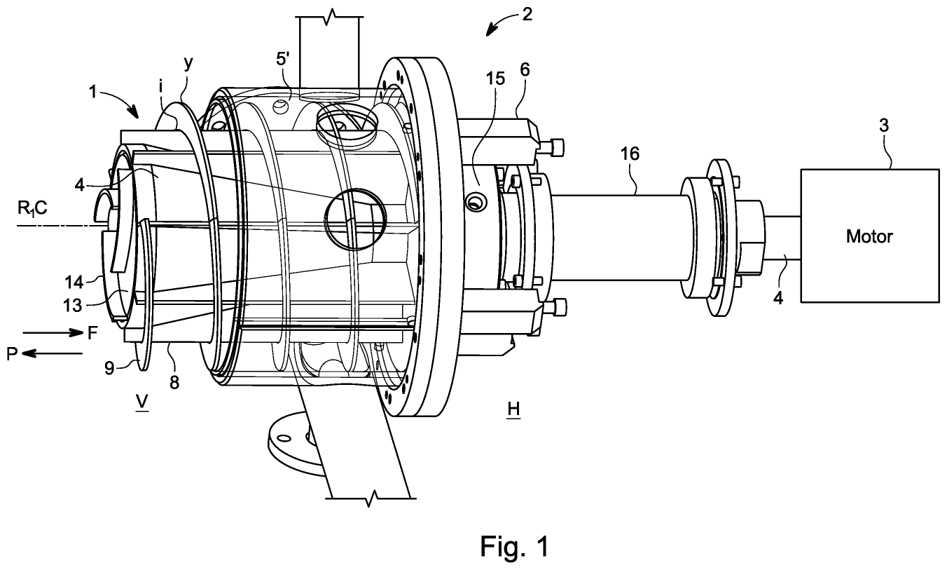

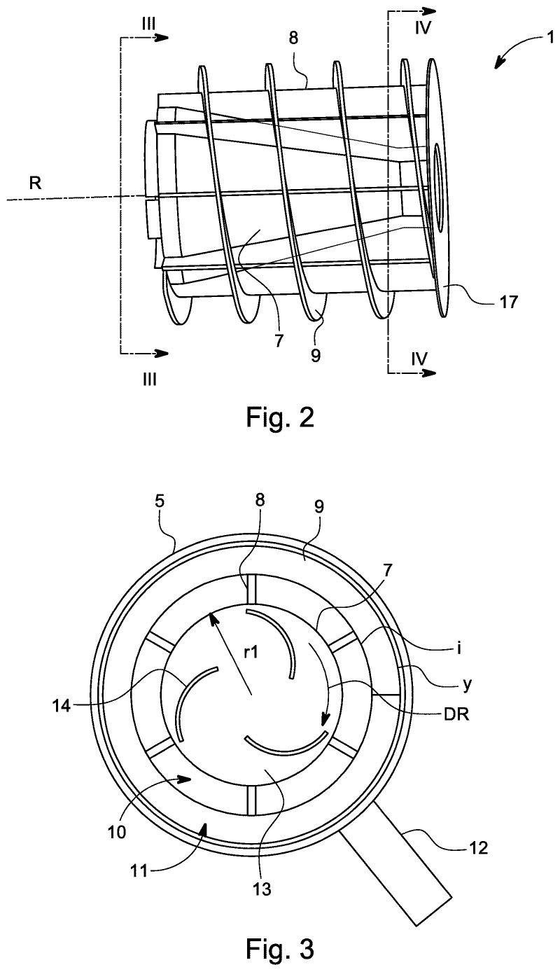

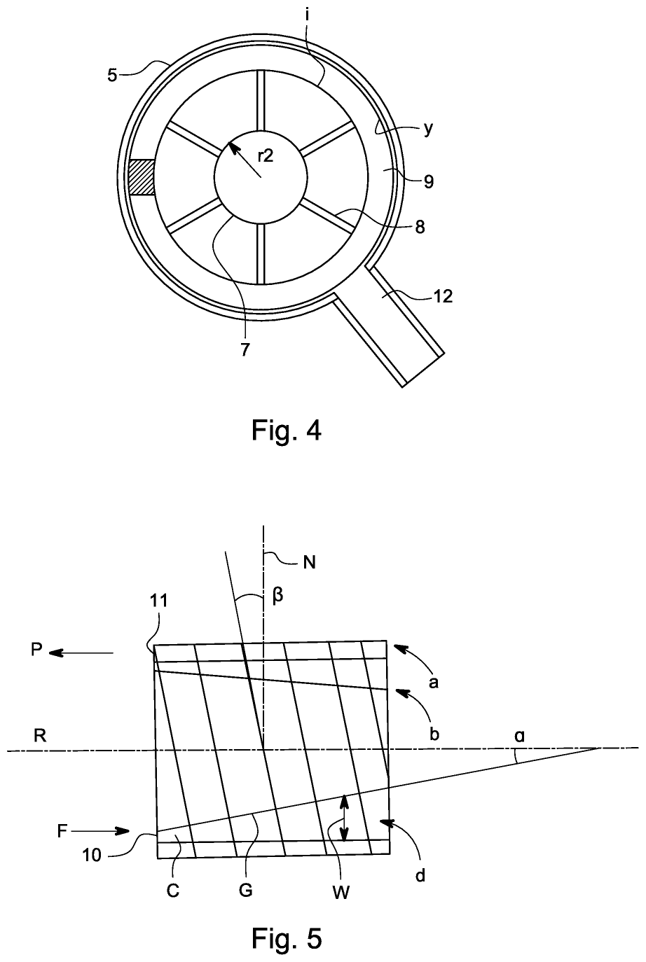

The device according to the invention comprises a rotor 1 rotatably arranged in a rotor housing 2, whereby a drive unit 3 is arranged to drive the rotor via a drive shaft 4 in rotation inside a cylindrical rotor housing wall 5. It should be noted here that in FIG. 1, an upstream part of the rotor housing wall 5 is broken away and the remainder of the rotor housing wall is shown transparent to clarify the design and extent of the rotor in the rotor housing. Rotor and rotor housing are coaxially aligned so that the axis of rotation R of the rotor coincides with a central axis C of the rotor housing. Rotor and rotor housing have an axial extension, between an upstream first end V (see left end of rotor and rotor housing in FIG. 1) with respect to the flow direction of a gas flow F through the rotor and a downstream second end H (see right end of rotor and rotor housing in FIG. 1). The rotor and rotor housing also have a radial extension perpendicular to the rotor axis and center axis, see also FIGS. 3 and 4.

At the downstream end, the rotor housing 2 can be arranged to support a bearing holder 6 for journaling the drive shaft 4, which is connected with its one end to the rotor 1 inside the rotor housing. The drive unit 3 at the opposite other end of the drive shaft is suitably an electric motor capable of driving the rotor at a speed of rotation in the order of 4000 to 5000 rpm (revolutions per minute).

The rotor 1 comprises a rotor core 7 which has a rotationally symmetrical shape and tapers conically in the direction of the downstream end of the rotor. In other words, the rotor core 7 has a first radius r1 at its upstream end and a second radius r2 at its downstream end, whereby r1 is greater than r2 (see FIGS. 3 and 4). The conicity may be such that a cone angle α (see FIG. 5), by which is meant the angle α between the axis of rotation R and a generatrix G in the mantle surface of the rotor core, is suitably in the order of 10°. Depending on the application, suitable cone angles may be assumed to lie within a range of 5° to 15°, and preferably within the range of 8° to 12°, without the invention being limited to said range.

The rotor 1 further comprises a number of wings 8 distributed around the circumference of the rotor core, which run in the axial direction of the rotor and extend radially outwards from the mantle surface of the rotor core. The wings 8 have, as viewed radially, an inner edge attached to the rotor core, while the outer edges of all wings, as viewed radially, are at the same radial distance from the axis of rotation R between the upstream end of the rotor and its downstream end. Due to the conicity of the rotor core, the width w of the wings in the radial direction of the rotor will thus grow successively in the direction of the downstream end of the rotor (see FIG. 5).

As in the embodiment example, the wings 8 may be straight and follow a generatrix in the mantle surface of the rotor core. The wings 8 may alternatively be curved and instead follow a curved line in the mantle surface of the rotor core.

A rail 9 is attached to the outer edges of the wings. The rail 9 is shaped into a spiral that runs around the rotor and extends from the downstream end of the rotor to its upstream end. The rail 9 is standing (raised) on one edge, by which is meant here that it has an inner periphery i connected to the wings 8, and an outer periphery y which runs just inside the rotor housing wall 5. The rail 9 thus forms a feed screw 9 which in its radial extent substantially fills an annular space between the wings 8 and the rotor housing wall 5. The feed screw 9 is suitably designed with a pitch angle β in the order of 5° to 10°, seen in relation to a normal N to the axis of rotation R. However, the feed screw 9 may, where appropriate, be designed with other pitch angles without departing from the invention.

In operation of the device, the rotor is rotated in a direction of rotation DR (see FIG. 3) which results in the wings 8 generating a centrifugal and accelerating force which forces solid particles, liquid and heavier gas fractions in the incoming mixed gas flow F to move outward and concentrate at the rotor housing wall, while the feed screw 9 is effective for the transport of separated heavier gas fractions, solid particles and liquids in the flow direction P of the upstream end V of the rotor, i.e. in the opposite direction to the mixed gas flow F.

From the above it is realized that the mixed gas flow F and the separated flow P containing separated heavier fractions of gas, solid particles and liquids meet at the upstream open end of the rotor housing 2. More specifically, an inlet 10 is formed here which is annular and limited to the radial distance between the rotor core 7 and the inner periphery i of the feed screw 9. Consequently, an annular return outlet 11 is formed which is limited to the radial distance between the inner periphery i of the feed screw and the rotor housing wall 5. It is also realized that if there is no physical separation between the incoming gas flow F and the return flow P some admixture of already separated material in the incoming gas flow F may occur. Such material returned in the incoming gas flow F will again be thrown out by the rotating rotor and the wings against the rotor housing wall to be discharged by the feed screw 9, so that mainly lighter gas, free of solid particles, liquid and heavier gas fractions, can be discharged in a radial direction via one or more gas outlets 12, connected to an opening in the rotor housing wall at the downstream end of the rotor housing. More specifically, a number of gas outlets 12 may be arranged in different positions along the circumference of the rotor housing.

It should also be explained here that the rotor core 7 may be shaped with an end plane 13 directed upstream, with convexly curved vane blades 14, protruding from the end plane and towards the gas/particle flow, in the direction of rotation DR of the rotor, which extend from an area inside the periphery of the rotor core to the peripheral edge of the rotor core. The purpose of the vane blades 14 is to feed solid particles and liquid, where applicable, from a process material, located upstream, into the mixed gas flow that is fed into the reactor housing 2.

It can also be added that the drive shaft bearing 15 may include a cooling jacket 16 to prevent overheating of the bearing due to high gas temperature through liquid cooling.

Furthermore, the rotor may be designed with an end plate or coupling flange 17 at its downstream end, in and for coupling to the drive shaft 4.

The device is shown here in an embodiment which is adapted for use in conjunction with a reactor of the type described in the above-mentioned WO2021/145816 A1. In this application, it is suitable to return separated material to the process going on in the reactor in order to gasify as much as possible of the treated starting material through grinding and through the heat developed in the reactor.

For this example of use, a device according to the invention may be designed with a rotor length of 500 mm and a rotor diameter of 500 mm. The diameter of the rotor core at the upstream end may be 300 mm, while the diameter at the downstream end may be 150 mm. Six wings may be angularly evenly distributed around the rotor core and may with their outer edges (during rotation) describe a cylinder with a diameter of 400 mm. The width of the spirally twisted rail, standing on one edge, that forms the feed screw in this example amounts to 20 mm.

By means of an electric motor with a power of 10-15 kW, the rotor of the example can be driven at 4500 rpm. At this speed of rotation, the wings generate an acceleration force in the order of 14000 G at the periphery of the wings (see FIG. 5, position a), while the acceleration force close to the rotor core is in the order of 7000 G at the downstream and narrowest end of the rotor core (position b). The flow velocity of a mixed gas flow F which at the inlet 10 (position c) amounts to about 4 m/s has been reduced to about 2 m/s at the gas outlet 12 (position d). At a pitch angle of the feed screw of 10° relative to the rotor shaft, the feed screw at the indicated speed of rotation will give separated solid particles, liquid droplets and/or heavier gas molecules a flow velocity (P) of approx. 90 m/s in the direction of the return outlet 11.

The above-mentioned specifications are only to be considered as examples and should not entail any limitation of the invention. The example may, however, serve as a guide for the person skilled in the art when practicing the invention.

1. A device for separating gas from a mixed gas flow which may contain light and heavier gas fractions, liquid, and/or solid particles, which device comprises:
a rotor rotatably arranged in a rotor housing with a cylindrical rotor housing wall, wherein the rotor and the rotor housing have a radial and axial extension and an axis of rotation of the rotor coincides with a center axis of the rotor housing,
a drive unit connected to the rotor and operative for rotation of the rotor;
an inlet arranged at an upstream first end of the rotor housing for feeding an axially directed mixed gas flow into the rotor;
a gas outlet arranged at a downstream second end of the rotor housing for discharging gas; and
a return outlet arranged at the upstream first end of the rotor housing for discharging an outlet flow of separated heavier gas fractions, solid particles, and/or liquids,
wherein the rotor comprises:
a rotor core which tapers conically from an upstream first end towards a downstream second end of the rotor with respect to a flow direction of the mixed gas flow through the rotor;
wings, arranged on the rotor core and running in a longitudinal direction, a width of said wings in a radial direction of the rotor increases in a direction towards the downstream second end of the rotor; and
a rail supported on free edges of the wings, arranged in a spiral path and standing on one edge, forming a rotating feed screw close to the rotor housing wall with a pitch designed for feeding separated heavier gas fractions, solid particles, and liquids towards the return outlet arranged at the upstream first end of the rotor housing.

2. The device according to claim 1, wherein an opening is formed through the rotor housing wall at the downstream second end of the rotor housing for discharging gas in a radial direction from the rotor housing.

3. The device according to claim 1, wherein the inlet for the mixed gas flow at the upstream first end of the rotor housing is annular and determined by the radial distance between the rotor core and an inner periphery of the feed screw, and wherein the return outlet at the upstream first end of the rotor housing is annular and determined by the radial distance between the inner periphery of the feed screw and the rotor housing wall.

4. The device according to claim 3, wherein the outlet flow of separated heavier gas fractions, solid particles and liquids, and the inlet flow of the mixed gas flow meet at the upstream first end of the rotor housing without a physical boundary between the flows.

5. The device according to claim 1, wherein a cone angle of the rotor core is in a range of 8° to 12°.

6. The device according to claim 1, wherein a pitch angle of the feed screw relative to a normal to the axis of rotation is in a range of 5° to 10°.

7. The device according to claim 1, wherein the drive unit is operatively connected to the rotor by the drive shaft being connected to a coupling flange arranged at the downstream end of the rotor.

8. The device according to claim 1, wherein the rotor core at its upstream end has an end plane directed towards the mixed gas flow, with convexly curved vane blades, protruding from the end plane and towards the mixed gas flow, in the direction of rotation of the rotor, which extend from an area inside the periphery of the rotor core to the peripheral edge of the rotor core.
